(19) United States
(12) Patent Application Publication
(10) Pub. No.: US 2015/0269131 A1
(43) Pub. Date: Sep. 24, 2015

(54) CONTENT CONVERSION APPARATUS AND METHOD, AND COMMUNICATION SYSTEM

(71) Applicant: KABUSHIKI KAISHA TOSHIBA, Tokyo (JP)

(72) Inventors: Mika MINEMATSU, Fuchu Tokyo (JP); Hiroyuki AIZU, Yokohama Kanagawa (JP); Kotaro ISE, Kawasaki Kanagawa (JP)

(73) Assignee: KABUSHIKI KAISHA TOSHIBA, Tokyo (JP)

(21) Appl. No.: 14/632,811

(22) Filed: Feb. 26, 2015

(30) Foreign Application Priority Data
Mar. 19, 2014 (JP) 2014-055783

(51) Int. Cl. G06F 17/22; G06F 17/24; G06F 17/21

(52) U.S. Cl. CPC G06F 17/2247; G06F 17/211; G06F 17/24

(57) ABSTRACT

According to an embodiment, a content conversion apparatus includes a converting unit, an analyzing unit, and a program generating unit. The converting unit is configured to convert a graphic element of content. The analyzing unit is configured to analyze a trigger at which a change occurs in a display of the content. The program generating unit is configured to generate a program for realizing the change in response to an input operation corresponding to the trigger.

### CROSS-REFERENCE TO RELATED APPLICATIONS

This application is based upon and claims the benefit of priority from Japanese Patent Application No. 2014-055783, filed Mar. 19, 2014, the entire contents of which are incorporated herein by reference.

### FIELD

Embodiments described herein relate generally to a content conversion apparatus and method, and a communication system including the content conversion apparatus.

### BACKGROUND

JP-A 2004-220260 (KOKAI) discloses a technique in which an image distribution server converts a web page into a bitmap image and transmits the image to a mobile terminal to enable the mobile terminal which is not equipped with a browser to browse the web page. However, in this technique, since the server processes a user's input operation for the web page, the operational responsiveness is low.

### BRIEF DESCRIPTION OF THE DRAWINGS

FIG. 1 is a block diagram showing a content conversion apparatus according to a first embodiment.

FIG. 2A is a diagram showing an example of an application according to an embodiment.

FIG. 2B is a diagram explaining the operation of the application shown in FIG. 2A.

FIG. 3 is a diagram showing a content example corresponding to the application shown in FIG. 2A and FIG. 2B.

FIG. 4 is a diagram showing a content example corresponding to the content shown in FIG. 3.

FIG. 5 is a flow chart showing the procedure of a content conversion processing according to the first embodiment.

FIG. 6 is a block diagram showing a content conversion apparatus according to a second embodiment.

FIG. 7 is a flow chart showing a content conversion processing according to the second embodiment.

FIG. 8 is a diagram explaining a working example of the content conversion apparatus shown in FIG. 6.

FIG. 9 is a block diagram showing a content conversion apparatus according to a third embodiment.

FIG. 10 is a flow chart showing a content conversion processing according to the third embodiment.

FIG. 11 is a flow chart showing content request processing of the client shown in FIG. 9.

FIG. 12 is a flow chart showing input operation processing of the client shown in FIG. 9.

FIG. 13 is a flow chart showing screen update generation processing according to the third embodiment.

FIG. 14 is a diagram showing an example of an application according to the third embodiment.

FIG. 15 is a diagram showing a content example corresponding to the application shown in FIG. 14.

FIG. 16A is a diagram showing an example of an application according to the third embodiment.

FIG. 16B is a diagram explaining the operation of the application shown in FIG. 16A.

FIG. 17 is a diagram showing a conversion content example corresponding to the application shown in FIG. 16A and FIG. 16B.

### DETAILED DESCRIPTION

According to an embodiment, a content conversion apparatus includes a converting unit, an analyzing unit, and a program generating unit. The converting unit is configured to convert a graphic element of content. The analyzing unit is configured to analyze a trigger at which a change occurs in a display of the content. The program generating unit is configured to generate a program for realizing the change in response to an input operation corresponding to the trigger.

Hereinafter, various embodiments will be described with reference to the drawings.

### First Embodiment

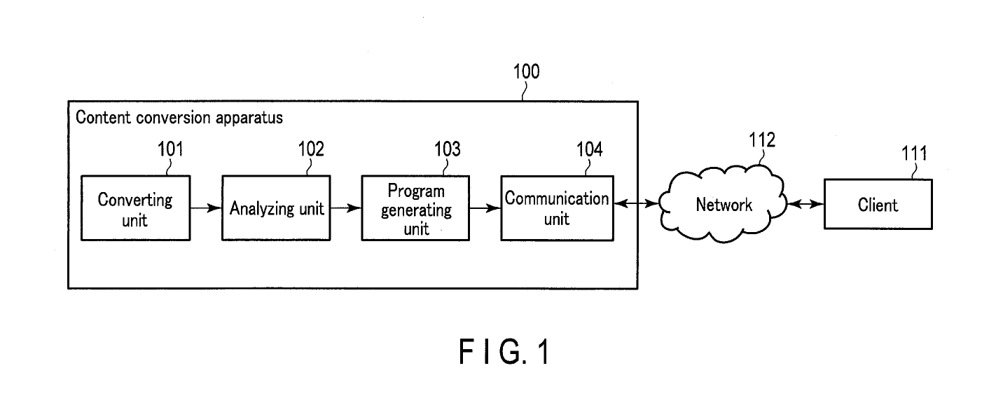

FIG. 1 schematically shows a content conversion apparatus 100 according to a first embodiment. The content conversion apparatus 100 shown in FIG. 1 provides content to a client (also called a client device) 111 which is connected via a network 112 such as the Internet. In the present embodiment and embodiments mentioned later on, an HTML (HyperTex Markup Language) file is used for the content. An HTML file is an example of the content. Therefore, the content should not be limited to the HTML file. The content conversion apparatus 100 includes a converting unit 101, an analyzing unit 102, a program generating unit 103, and a communication unit 104.

The converting unit 101 converts a graphic element of the content. For example, the converting unit 101 converts an SVG (Scalable Vector Graphics) element of the HTML file into a Div element. The analyzing unit 102 analyzes the trigger at which a change in display of the content occurs, and notifies the result of analysis to the program generating unit 103.

Based on the result of analysis received from the analyzing unit 102, the program generating unit 103 generates a program (hereinafter referred to as operation script) for realizing the change in response to an input operation corresponding to the trigger. The communication unit 104 communicates with the client 111 through the network 112. The communication unit 104 transmits the conversion content including the graphic element converted by the converting unit 101 and the operation script generated by the program generating unit 103 to the client 111. For example, the communication unit 104 receives a content distribution request from the client 111, and transmits the conversion content to the client 111 in response to the request. The converted graphic element and the operation script may be described in a document (for example, an HTML document) or may be described in individual documents.

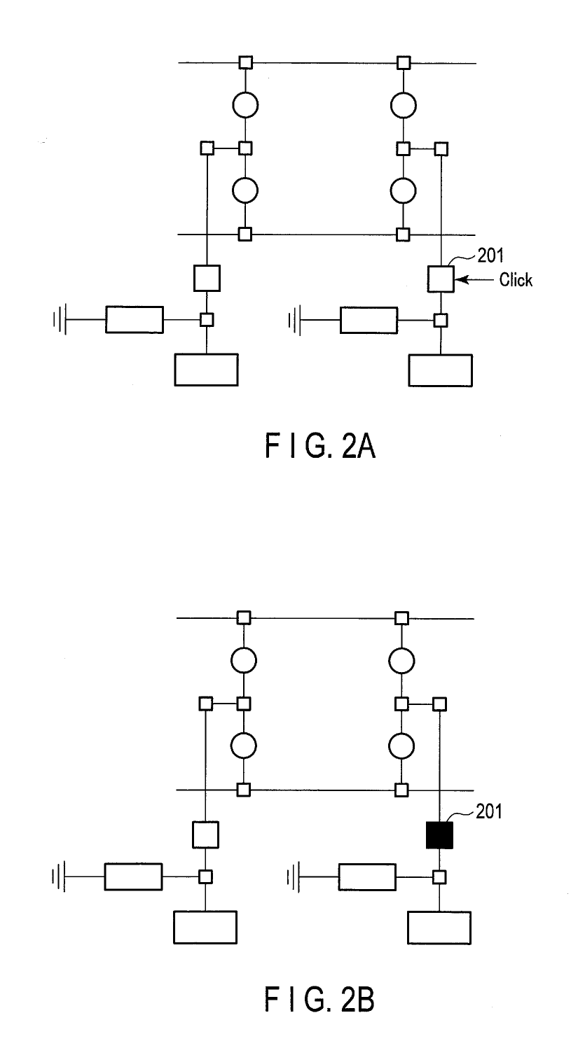

FIG. 2A shows an example of an application according to the present embodiment. The application shown in

FIG. 2A is a web application which, when one of the elements on a single-line diagram on which a plurality of elements such as squares, circles, and lines are arranged is clicked, changes the colors of the clicked element. For example, when a square element 201 is clicked, as shown in FIG. 2B, the color of the element 201 changes to black.

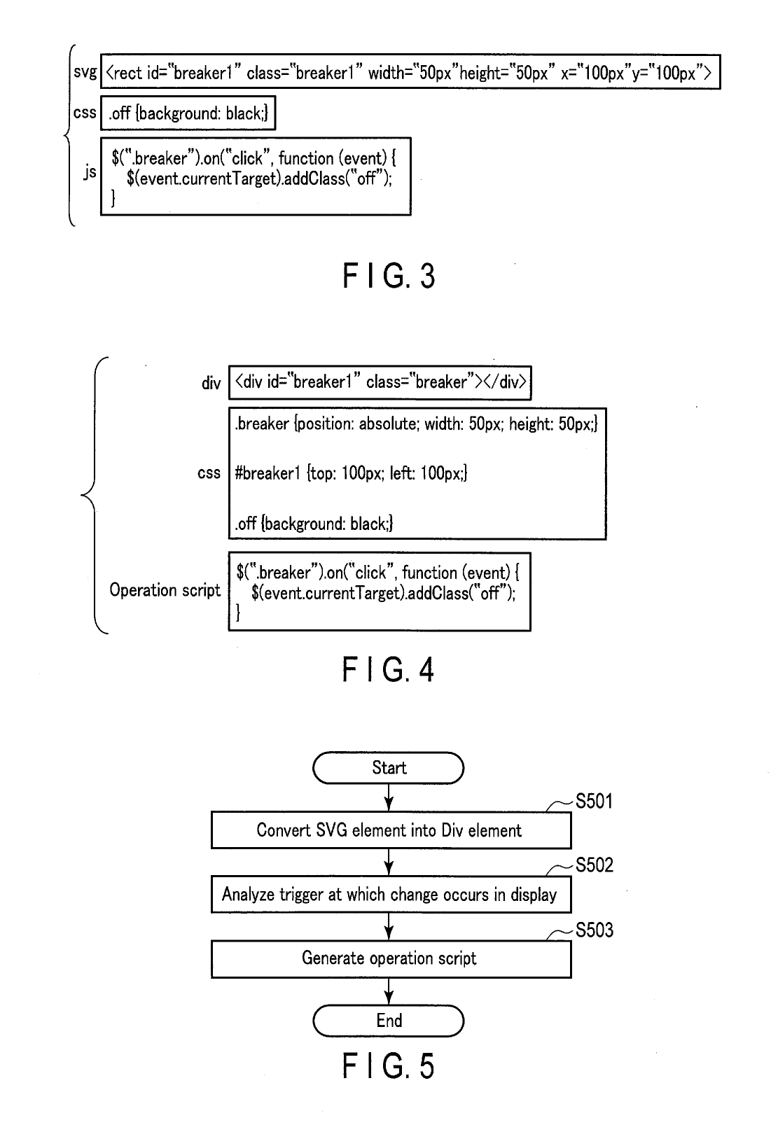

FIG. 3 shows a content example corresponding to the application shown in FIG. 2A and FIG. 2B. As shown in FIG. 3, the content includes the SVG element for displaying the single-line diagram, a CSS (Cascading Style Sheets) for defining the appearance of the application, and a Java Script® for changing the display in response to the input operation. In FIG. 3, only the SVG element regarding the element 201 of FIG. 2A is shown. However, the content actually includes SVG elements for all of the elements shown in FIG. 2A. The content may also include bitmap images etc.

FIG. 4 shows a conversion content example obtained by the content conversion apparatus 100 converting the content shown in FIG. 3. As shown in FIG. 4, the conversion content includes the Div element, the CSS and the operation script. In the CSS of the conversion content, size information and position information included in the SVG element are added. At the client 111, an image (in this example, the single-line diagram shown in FIG. 2A) based on the Div element and the CSS included in the conversion content is displayed. The processing when one of the elements in the single-line diagram of FIG. 2A is clicked is executed at the client 111 in accordance with the operation script.

FIG. 5 schematically shows the content conversion processing executed by the content conversion apparatus 100. In step S501 of FIG. 5, the converting unit 101 converts the SVG element of the HTML file into the Div element. The converting unit 101 describes the size information and the position information of the element corresponding to the Div element on the CSS. Since the processing load of the Div element is lower than the processing load of the SVG element, the display rate can be improved by converting the SVG element to the Div element.

In step S502, the analyzing unit 102 analyzes the trigger at which the change in display of the content occurs. The trigger at which the change in display of the content occurs is found by analyzing the Java Script program included in the content. In the example of FIG. 3, jQuery, which is a Java Script frame work, is used. The addClass method of the jQuery is used to change the display.

In this case, the analyzing unit 102 analyzes the trigger at which the addClass method is called and detects that the display is changed by clicking the element of the breaker class. The analyzing unit 102 further detects that the color of the element changes to black by analyzing the CSS. The following methods can be used as methods for analyzing the trigger at which the change in display occurs, for example: a method in which a list of methods for changing the display, such as the addClass method, is kept and the trigger at which the method included in the content is called is determined with reference to the list; or a method in which a tag indicating the trigger at which the change occurs is given in advance when creating the content.

In step S503, the program generating unit 103 generates the operation script based on the result of the analysis according to the analyzing unit 102. In the example of FIG. 3, the program generating unit 103 generates an operation script for changing the color of the element of the breaker class to black in response to the click operation on this element.

The content is, for example, displayed using a browser. The browser may operate on the content conversion apparatus 100, or on a terminal (for example, client 111) which is different from the content conversion apparatus 100. The browser is capable of processing a screen change within the browser by the operation script.

As described above, in the content conversion apparatus according to the first embodiment, operation responsiveness may be improved by generating the operation script for screen updating using the Div element and the CSS.

### Second Embodiment

In the first embodiment, an example of screen updating using the Div element and the CSS was explained. In a second embodiment, an example of screen updating using a bitmap image will be explained.

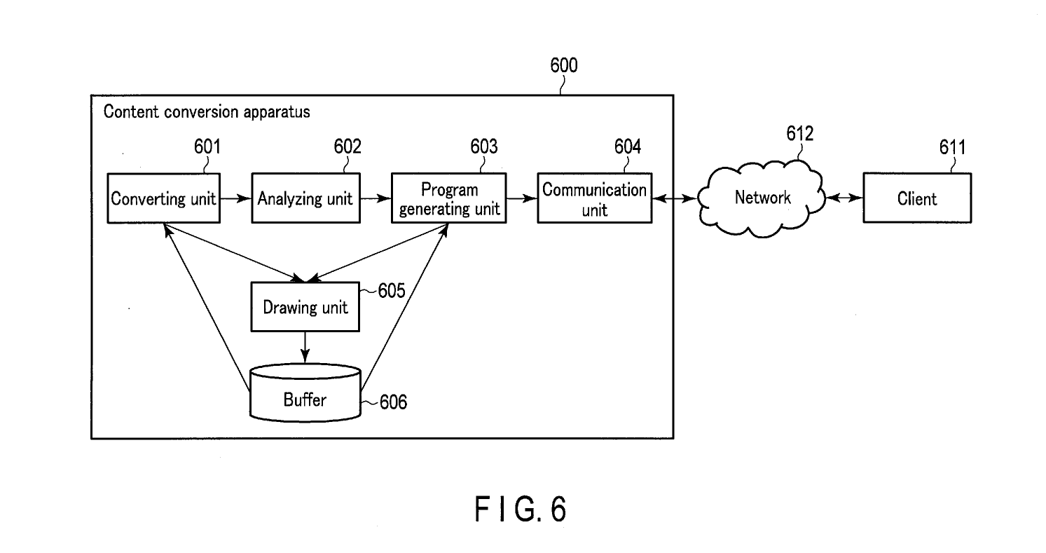

FIG. 6 schematically shows a content conversion apparatus 600 according to the second embodiment. The content conversion apparatus 600 shown in FIG. 6 provides content to a client 611 which is connected via a network 612. Specifically, the content conversion apparatus 600 includes a converting unit 601, an analyzing unit 602, a program generating unit 603, a communication unit 604, a drawing unit 605, and a buffer 606. The analyzing unit 602 and the communication unit 604 perform the same operation as the analyzing unit 102 and the communication unit 104 (FIG. 1) explained in the first embodiment. Therefore, explanations of the analyzing unit 602 and the communication unit 604 will be omitted as appropriate.

The converting unit 601 converts an SVG element of an HTML file into a bitmap image using the drawing unit 605. The drawing unit 605 generates image information based on the SVG element of the HTML file in accordance with the instruction from the converting unit 601 and writes the image information into the buffer 606. The program generating unit 603 instructs the drawing unit 605 to generate image information (bitmap image) of the display after it has changed in response to an input operation. The buffer 606 stores the image information generated by the drawing unit 605. The buffer 606 may be implemented in any generally utilized recording medium such as RAM (Random Access Memory), an HDD (Hard Disk Drive), an optical disk, or a memory card.

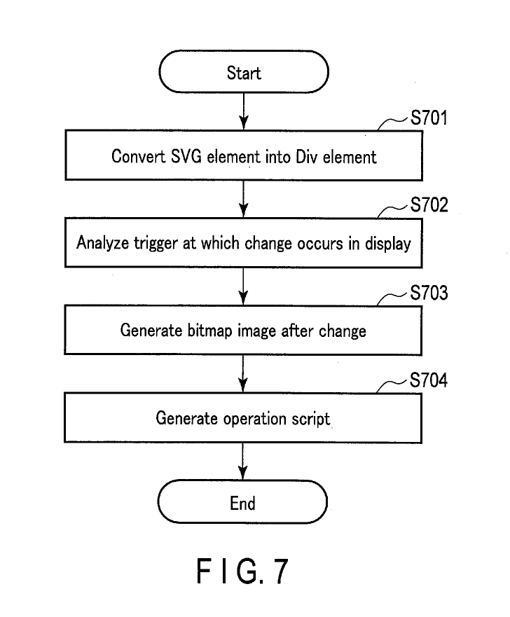

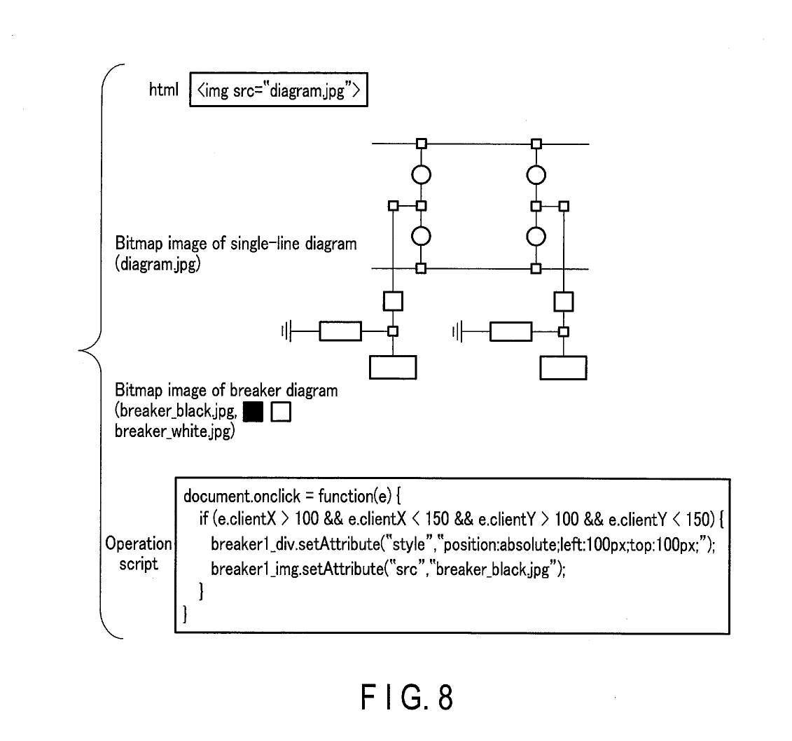

FIG. 7 schematically shows content conversion processing performed by the content conversion apparatus 600. In step S701 of FIG. 7, the converting unit 601 converts the SVG element of the HTML file into a bitmap image. Specifically, the drawing unit 605 generates image information based on the SVG and CSS included in the content in accordance with the instruction from the converting unit 601 and stores this image information in the buffer 606. For example, when attempting to display the content of FIG. 3 using a browser, a drawing instruction for drawing the single-line diagram of FIG. 2 is issued, and the drawing unit 605 draws the single-line diagram in the buffer 606 in accordance with the drawing instruction. The converting unit 601 obtains the image information from the buffer 606 and rewrites the SVG element of the HTML file into an IMG element so as to refer to this image information. The IMG element is one of html elements. The images may be compressed. For example, the images are compressed in the JPEG format. FIG. 8 shows a conversion content example obtained by converting the content example of FIG. 3 in accordance with the second embodiment. As shown in FIG. 8, the image information generated by the drawing unit 605 is stored under the name of “diagram.jpg”, and the graphic element is converted so as to refer this diagram.jpg.

In step S702, the analyzing unit 602 analyzes the trigger at which the change in display of the content occurs. Since the processing in step S702 is the same as the processing in step S502 shown in FIG. 5, a detailed explanation will be omitted.

In step S703, the program generating unit 603 uses the drawing unit 605 to generate the changed image information. In the example of FIG. 3, the program generating unit 603 generates image information of the element of the breaker class which is colored black. The image information may be generated by any method. For example, it can be generated by a method which analyzes size information of an element and draws a black square in the size of the element, or a method which generates a click event using a browser and has the browser issue a drawing instruction for changing the color of the element to black. The program generating unit 603 acquires the image information of the element which is colored black from the buffer 606, and stores it. For example, as shown in FIG. 8, the program generating unit 603 compresses the image information in JPEG format and stores it under the name of “breakerblack.jpg”. As for the changed image information, it is also fine to obtain a difference image from a backup image before the change, or to calculate a region to be converted from the JavaScript program and obtain the image of the region. For example, in a case where a certain element is reduced in response to a click operation, the image information of the reduced size is generated as the changed image information.

In step S704, the program generating unit 603 generates the operation script based on the analysis result according to the analyzing unit 602. In the example of FIG. 3, the program generating unit 603 generates the operation script for changing the color of this element of a breaker class to black in response to the click operation on this element. Unlike the SVG element and the Div element which are capable of designating size information and position information for each element, when converted to the bitmap image, it becomes unclear as to where the element of the breaker class exists. For example, in the example of FIG. 3, the element of the breaker class is displayed in a region designated by a coordinate (100, 100), with a width of 50 pixels, and a height of 50 pixels on an application screen. In this case, as shown in FIG. 8, the program generating unit 603 determines that the element of the breaker class has been clicked if the click position is from 100 to 150 at the X-coordinate and 100 to 150 at the Y-coordinate, and generates the operation script for displaying breaker_black.jpg at the position of this element.

As described above, in the content conversion apparatus according to the second embodiment, operation responsiveness may be improved by generating the operation script for screen updating using the bitmap image.

### Third Embodiment

In the third embodiment, an example of switching between a client and a content conversion apparatus to execute screen updating (processing to change the display of content) is explained.

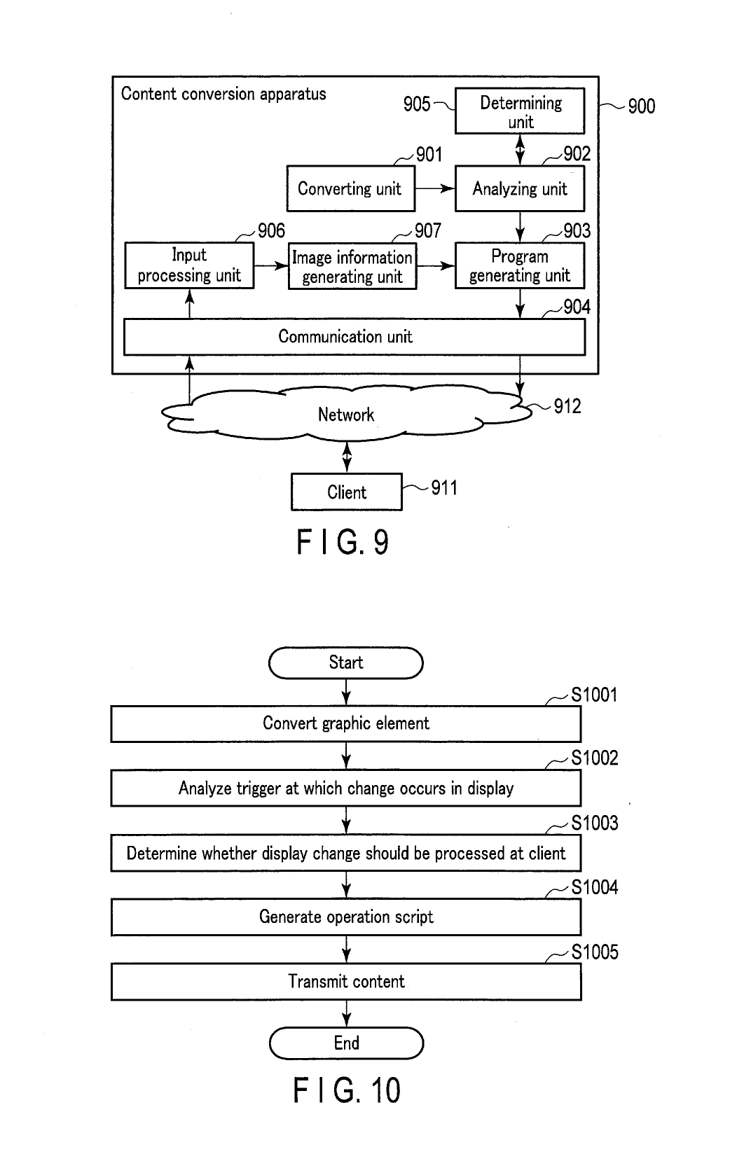

FIG. 9 schematically shows a content conversion apparatus 900 according to the third embodiment. The content conversion apparatus 900 shown in FIG. 9 provides content to a client 911 which is connected via a network 912. Specifically, the content conversion apparatus 900 comprises a converting unit 901, an analyzing unit 902, a program generating unit 903, a communication unit 904, a determining unit 905, an input processing unit 906, and an image information generating unit 907. The converting unit 901 and the analyzing unit 902 perform the same operation as the converting unit 101 and the analyzing unit 102 (FIG. 1) explained in the first embodiment. Therefore, explanations of the converting unit 901 and the analyzing unit 902 will be omitted as appropriate. The converting unit 901 may perform the same operation as the converting unit 601 (FIG. 6) explained in the second embodiment.

The determining unit 905 determines whether to execute the processing for realizing a change accompanying an input operation (screen updating) at the client 911 or at the content conversion apparatus 900. If the analyzing unit 902 detects a plurality of triggers, the determining unit 905 performs determining for each of the plurality of triggers.

For the screen updating that the determining unit 905 determines should be executed at the client 911, the program generating unit 903 generates an operation script for executing the screen updating at the client 911. For the screen updating that the determining unit 905 determines should be executed at the content conversion apparatus 900, the program generating unit 903 generates an operation script for transmitting input operation information to the content conversion apparatus 900 in order to execute the screen updating at the content conversion apparatus 900.

The communication unit 904 communicates with the client 911 through a network 112. The communication unit 904 transmits the conversion content including the graphic element converted by the converting unit 901 and the operation script generated by the program generating unit 903 to the client 911. The communication unit 904 receives input operation information from the client 911. The communication unit 904 transmits the image information generated by the image information generating unit 907.

The input processing unit 906 performs input processing for the input operation information received from the client 911. Specifically, the image information generating unit 907 generates image information corresponding to the change accompanying the input processing. The image information may be in any format. For example, the image information may be a combination of a Div element and CSS, or a bitmap image.

FIG. 10 schematically shows content conversion processing performed by the content conversion apparatus 900. Since the processing in steps S1001 and S1002 shown in FIG. 10 are the same as the processing in steps S502 and S502 shown in FIG. 5, a detailed explanation will be omitted. In step S1001, the converting unit 901 converts a graphic element of the content. In step S1002, the analyzing unit 902 analyzes the trigger at which the change in display of the content occurs.

In step S1003, the determining unit 905 determines, for each trigger, whether to execute the screen updating at the client 911 or at the content conversion apparatus 900. This may be determined by any method. For example, the determining unit 905 may determine the screen updating to be processed at the client 911 if the area of a portion where the image changes is less than a threshold value, or at the content conversion apparatus 900 if the area where the image changes is equal to or greater than the threshold value. The determining unit 905 may also determine the screen updating to be processed at the client 911 if the data size of the image information after the change is smaller than a threshold value, or at the content conversion apparatus 900 if the data size of the image information after the change is equal to or greater than the threshold value. The determining unit 905 may also determine the screen updating to be processed at the client 911 if the number of elements changing the image is less than a threshold value, or at the content conversion apparatus 900 if the number of elements changing the image is equal to or greater than the threshold value. The determining unit 905 may also determine the screen updating to be processed at the client 911 if the display time of the change is shorter than a threshold value, or at the content conversion apparatus 900 if the display time of the change is equal or greater than the threshold value. For the display time, histories or the test results at the content conversion apparatus 900 may be used. The determining unit 905 may also determine the screen updating to be processed at the client 911 if the frequency of the occurrence of change is smaller than a threshold value, or at the content conversion apparatus 900 if the frequency of the occurrence of change is equal to or greater than the threshold value. The determining unit 905 may also determine a screen updating to be processed at the client 911 if the code quantity of an operation script corresponding to the change is less than a threshold value, or at the content conversion apparatus 900 if the code quantity of the operation script corresponding to the change is equal to or greater than the threshold value. The determining unit 905 may also determine whether to process the screen updating at the client 911 or at the content conversion apparatus 900 in accordance with the position (for example, a click position) of the input operation causing the change to occur. The determining unit 905 may also determine whether to process the screen updating at the client 911 or at the content conversion apparatus 900 in consideration of the bandwidth of the network 912 or the performance of the client terminal 911. For example, in the case where the network bandwidth is narrow, the threshold value may be set to a larger value so that the screen updating may be processed at the client 911. In the case where the performance of the client terminal is low, the threshold value may be set to a smaller value so that the screen updating may be processed at the content conversion apparatus 900. The determining unit 905 may determine whether to process the screen updating at the client 911 or at the content conversion apparatus 900 by combining the above-mentioned methods. In other words, the determining unit 905 may determine whether to process the screen updating at the client 911 or at the content conversion apparatus 900 based on at least one of the area of the change, the data size of the image information after the change, the number of elements included in the change, the display time of the change, the frequency of occurrence of the change, the processing quantity for realizing the change, the input operation information, the network performance, and the client performance.

In step S1004, the program generating unit 903 generates the operation script in accordance with the analysis result of the analyzing unit 902 and the determination result of the determining unit 905. The program generating unit 903 generates, for the screen updating determined by the determining unit 905 to be processed at the client 911, an operation script for processing the screen updating at the client 911, and, for the screen updating determined to be processed at the content conversion apparatus 900 by the determining unit 905, an operation script for transmitting the input operation information to the content conversion apparatus 900, so that the screen updating is executed at the content conversion apparatus 900. In step S1005, the communication unit 904 transmits the conversion content to the client 911.

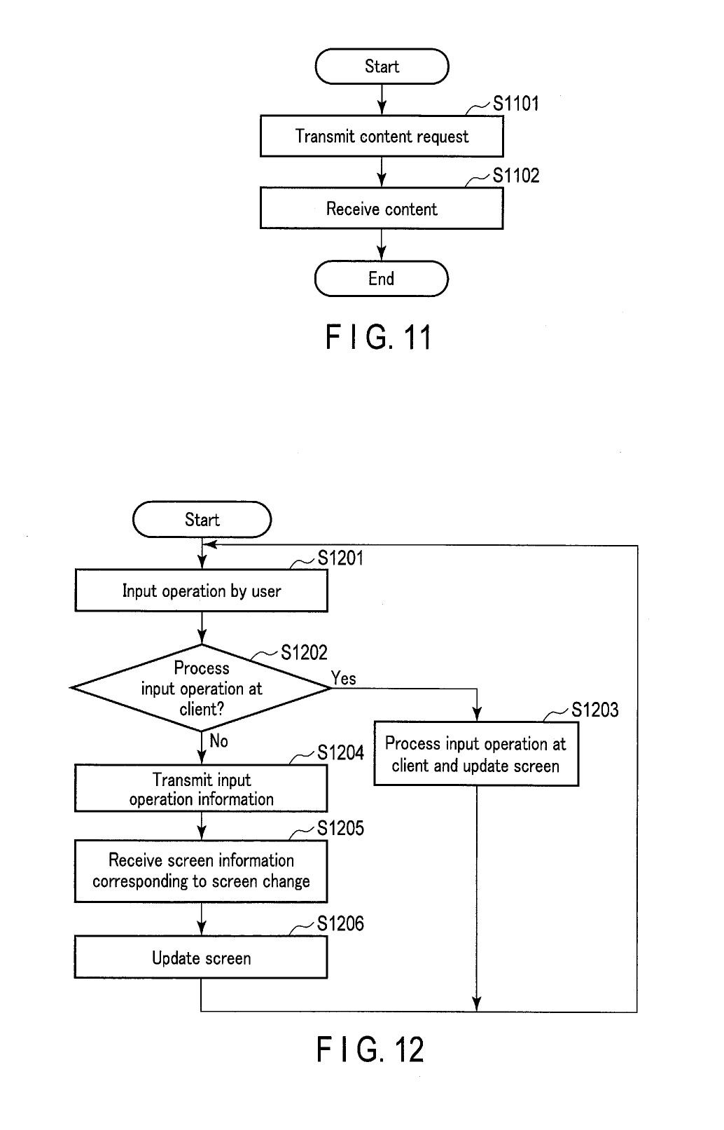

The operation of the client 911 will be explained with reference to FIG. 11 and FIG. 12.

In step S1101 of FIG. 11, the client 911 requests content distribution from the content conversion apparatus 900. In step S1102, the client 911 receives the conversion content from the content conversion apparatus 900. The client 911 displays an image based on the conversion content.

In step S1201 of FIG. 12, the client 911 accepts input operation from a user in a state where the image is displayed. In step S1202, the input operation is determined whether or not to be processed at the client 911 based on the operation script. In other words, it is determined whether or not a screen change accompanying the input operation is to be executed by the client 911. In the case of processing the input operation by the client 911, the client 911 processes the input operation and updates the screen (step S1203). Subsequently, the client 911 awaits for the next input operation.

In the case where the input operation is not processed by the client 911, the client 911 transmits information of the input operation to the content conversion apparatus 900 (step S1204). In step S1205, the client 911 receives image information corresponding to the screen change accompanying the input operation. In step S1206, the client 911 updates the screen based on the received image information. Subsequently, the client 911 awaits for the next input operation.

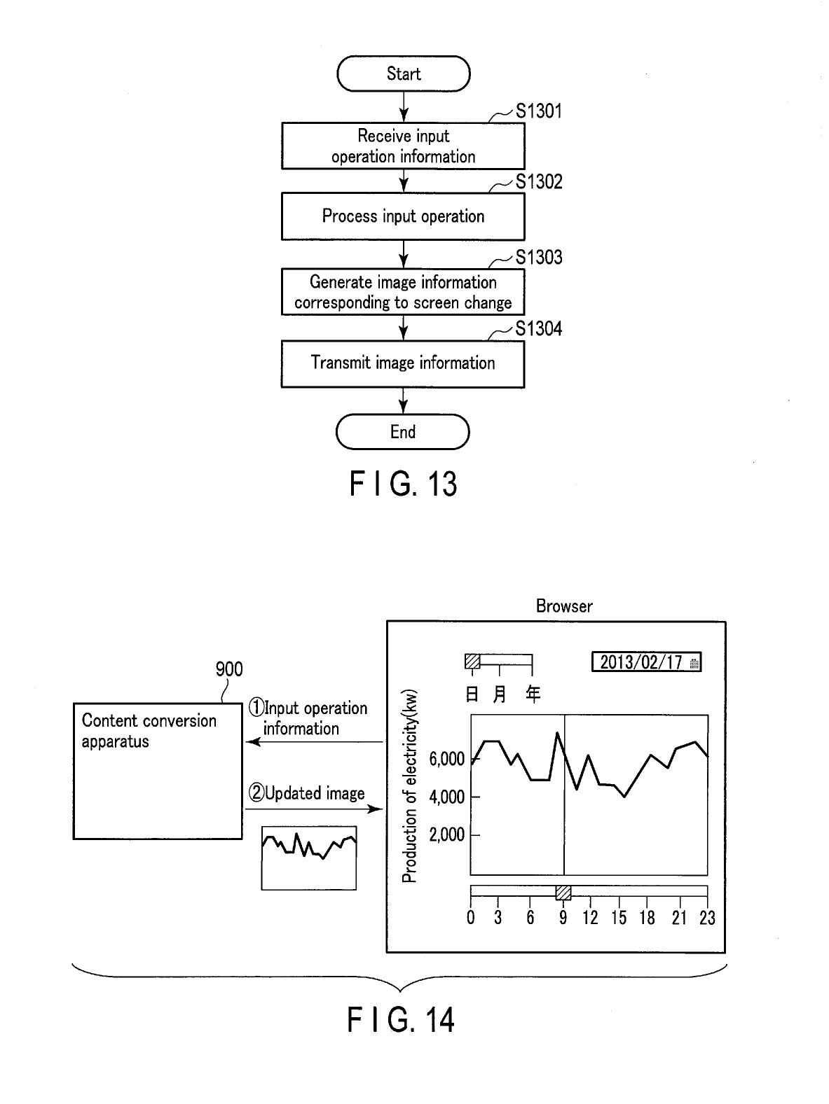

FIG. 13 schematically shows update image generating processing according to the content conversion apparatus 900. In step S1301 in FIG. 13, the communication unit 904 receives input operation information from the client 911. In step S1302, the input processing unit 906 processes the received input operation. For example, the input processing unit 906 processes the input operation using a browser. For example, in the case of receiving input operation information indicating that a click has occurred at a position of coordinate (100, 100) on a browser screen of the client, the input processing unit 906 emulates as if the click has occurred at a position of coordinate (100, 100) on a browser screen of the content conversion apparatus 900 using the browser. In step S1303, the image information generating unit 907 generates image information corresponding to the change accompanying the input processing. In step S1304, the communication unit 904 transmits the image information to the client 911. The image information may be transmitted alone or with an operation script designating a display method of the image information.

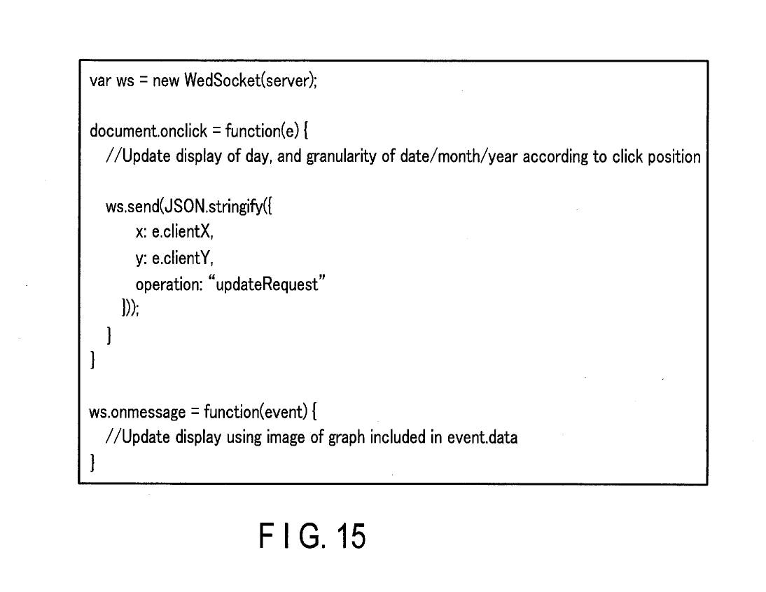

FIG. 14 shows an example of an application according to the present embodiment, and FIG. 15 shows a content example corresponding to the application of FIG. 14. The application shown in FIG. 14 is a web application which, when a user designates a date and granularity (for example, day, month, year), acquires corresponding data from a database, and generates and displays a graph based on the data. For example, in the case where the determining unit 905 determines whether to process the screen updating at the client 911 or at the content conversion apparatus 90 based on a display time or code quantity, as shown in FIG. 15, the program generating unit 903 generates an operation script so as to have the client process the portion designating the date and granularity, and to have the content conversion apparatus 900 process a graph portion.

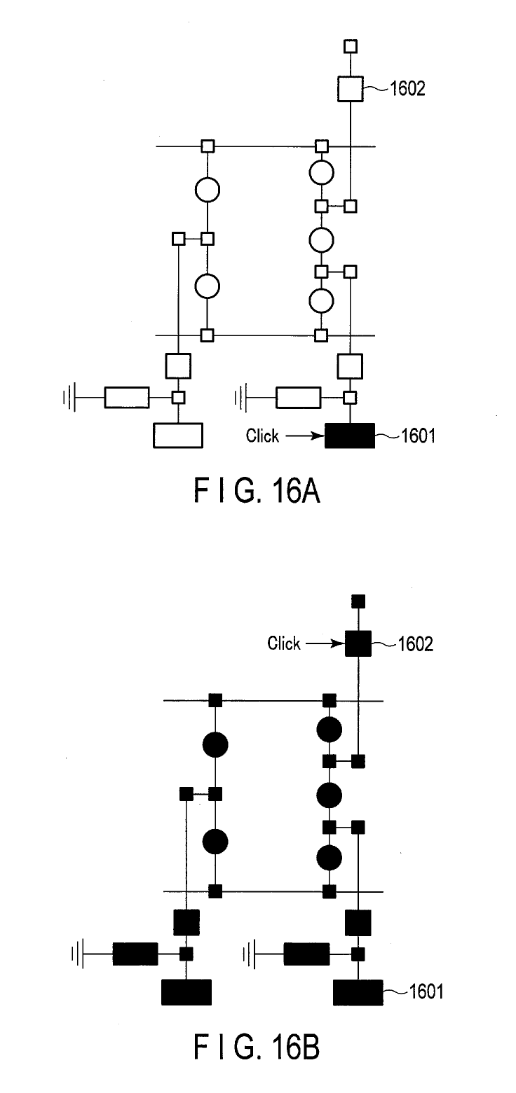

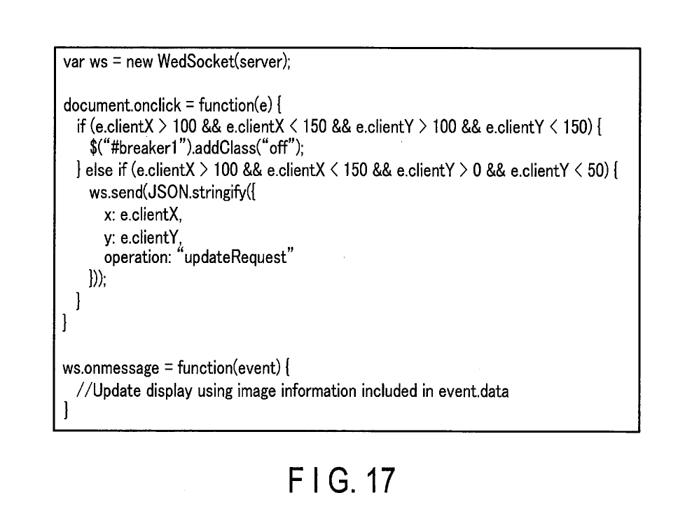

FIG. 16A and FIG. 16B show another example of an application according to the present embodiment, and FIG. 17 shows a conversion content example corresponding to the application shown in FIG. 16A and FIG. 16B. This application is such that, when one of the elements on a single-line diagram is clicked, the color of the clicked element and elements positioned on a terminal side of the clicked element changes. For example, as shown in FIG. 16A, when element 1601 of the terminal is clicked, the color of the element 1601 changes. As shown in FIG. 16B, when element 1602 at the root is clicked, the color of the element 1602 and elements positioned on the terminal side of the element 1602 changes. In the conversion content shown in FIG. 17, processing subjects (client 911 and content conversion apparatus 900) are switched in accordance with the click position. Specifically, when the click position is from 100 to 150 at the X-coordinate, and is from 100 to 150 at the Y-coordinate, the client 911 updates the screen, and when the click position is from 100 to 150 at the X-coordinate, and is from 0 to 50 at the Y-coordinate, the click position is transmitted to the communicating unit 904 of the content conversion apparatus 900, and the image information generated by the image generating unit 907 of the content conversion apparatus 900 is used to update the screen.

As described above, according to the third embodiment, the content conversion apparatus can be applied for a distribution processing system in which processing is shared between the content conversion apparatus and the client.

According to at least one of the embodiments mentioned above, operation responsiveness can be improved by generating a program for processing an input operation at the client side.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content conversion apparatus comprising:
a converting unit configured to convert a graphic element of content;
an analyzing unit configured to analyze a trigger at which a change occurs in a display of the content; and
a program generating unit configured to generate a program for realizing the change in response to an input operation corresponding to the trigger.

2. The apparatus according to claim 1, further comprising a determining unit configured to determine which of a client and the content conversion apparatus should execute processing for realizing the change accompanying the input operation, wherein
if the determining unit determines that the processing should be executed at the client, the program generating unit generates the program for executing the processing at the client, and if the determining unit determines that the processing should be executed at the content conversion apparatus, the program generating unit generates the program for transmitting information of an input operation to the content conversion apparatus.

3. The apparatus according to claim 2 further comprising:
a transmitting unit configured to transmit conversion content including the converted graphic element and the program to the client;
a receiving unit configured to receive information of an input operation with respect to the conversion content from the client; and
an input processing unit configured to execute input processing with respect to the input operation.

4. The apparatus according to claim 3, further comprising an image information generating unit configured to generate image information corresponding to the change accompanying the input processing, wherein
the transmitting unit transmits the image information to the client.

5. The apparatus according to claim 4, wherein the determining unit performs determining based on at least one of area of the change, data size of the image information, elements of the change in number, display time of the change, frequency of occurrence of the change, processing quantity for causing the change, information of input operation, network performance, and client performance.

6. A communication system comprising a content conversion apparatus and a client, the content conversion apparatus comprising:
a converting unit configured to convert a graphic element of content;
an analyzing unit configured to analyze a trigger at which a change in display of the content occurs;
a program generating unit configured to generate a program for realizing the change in response to an input operation corresponding to the trigger; and
a transmitting unit configured to transmit conversion content including the converted graphic element and the program to the client.

7. A content conversion method comprising:
converting a graphic element of content;
analyzing a trigger at which a change in display of the content occurs; and
generating a program for realizing the change in response to an input operation corresponding to the trigger.
